(19) United States
(12) Patent Application Publication
(10) Pub. No.: US 2026/0253472 A1
(43) Pub. Date: Aug. 27, 2026

(54) METHOD, APPARATUS AND PROGRAM FOR PROVIDING LAUNDRY MANAGEMENT SERVICE

(71) Applicants: NURI Global Service Co., Ltd., Seoul (KR); InnoAscend Co., Ltd., Seoul (KR)

(72) Inventor: Taejin PARK, Seoul (KR)

(73) Assignees: NURI Global Service Co., Ltd., Seoul (KR); InnoAscend Co., Ltd., Seoul (KR)

(21) Appl. No.: 19/549,181

(22) Filed: Feb. 25, 2026

(30) Foreign Application Priority Data
Feb. 25, 2025 (KR) 10-2025-0023999

(51) Int. Cl. G07F 17/20; D06F 34/05

(52) U.S. Cl. CPC G07F 17/20; D06F 34/05

(57) ABSTRACT

Disclosed is a method for providing a laundry management service according to various embodiments of the present invention. The method may include: generating a pickup request for laundry corresponding to the received laundry reception request from a user terminal and transmitting the generated pickup request to an operator terminal; acquiring washing information from the operator terminal as the pickup and classification for the laundry is completed; and providing the washing information and cost information corresponding to the washing information to the user terminal.

### [CROSS-REFERENCE PARAGRAPH]

This application claims the benefit of priority to Korean Patent Application No. 10-2025-0023999 filed on Feb. 25, 2025, the entire contents of which is incorporated herein by reference.

### TECHNICAL FIELD

The present invention relates to a method, an apparatus, and a program for providing a laundry management service, and more particularly, to a method, an apparatus, and a program for providing a laundry management service capable of efficiently managing a user's laundry reception, pickup, classification, laundry progress, cost calculation, and delivery.

### BACKGROUND OF THE INVENTION

Recently, as the importance of customized services has increased in various industries, the need for digital transformation and automation is also being emphasized in the laundry management service in line with this trend. In particular, in places such as accommodation facilities, hospitals, and luxury apartment complexes, the demand for services that efficiently handle the process of receiving, managing, washing, and delivering laundry and maximize customer convenience is increasing rapidly.

Conventional laundry management methods mainly rely on manual work or only use simple systems that digitize some steps. For instance, when a customer requests a laundry reception, the manager records it and sends it to the operator, and after that, it is difficult to manually update the progress or provide individual guidance to the customer. This method not only shows limitations in the speed and accuracy of work processing, but is also likely to cause customer complaints or lower the reliability of services due to the lack of real-time information provision.

In particular, during times when customer requests are concentrated, it is difficult for workers and managers to efficiently process laundry pick-up and delivery requests, and confusion is often aggravated by missing information or incorrect data. Such a situation may cause various problems such as loss of laundry, delay in delivery, and error in cost information. In addition, the lack of the ability to provide customized services by reflecting the individual requirements of customers or to create additional value based on promotional information is also a factor that weakens the competitiveness of the service.

Accordingly, there is a demand for new technologies that systematically integrate and manage the entire process from laundry reception to pickup, laundry progress, and delivery, and provide real-time feedback and optimized services to both users and workers. In this regard, Korean Patent Application Publication No. 10-2019-0134038 discloses a laundry service providing system and a management system thereof.

### SUMMARY OF THE INVENTION

### Problems to be Solved

An object of the present invention is to provide a method, apparatus, and program for providing a laundry management service in response to the above-described background technology.

The technical problems of the present disclosure are not limited to the technical problems mentioned above, and other technical problems not mentioned will be clearly understood by those skilled in the art from the following description.

### Means for Solving the Problem

According to an embodiment of the present invention for solving the above-described problems, a method for providing a laundry management service is disclosed. The method may include: generating a pickup request for laundry corresponding to the received laundry reception request from a user terminal and transmitting the generated pickup request to an operator terminal; acquiring washing information from the operator terminal as the pickup and classification for the laundry is completed; and providing the washing information and cost information corresponding to the washing information to the user terminal.

In an alternative embodiment, the method may further include: transmitting a washing start signal for the laundry to the operator terminal when the washing confirmation input signal is obtained from the user terminal; and transmitting a delivery location obtained from the user terminal to the operator terminal and obtaining delivery information from the operator terminal when the washing of the laundry is completed.

In an alternative embodiment, the receiving of the laundry reception request from the user terminal may include: obtaining a room number from the user terminal; obtaining voice data or text data requesting reception of the laundry from the user terminal, and converting the voice data into text data when the voice data is obtained; and recognizing reception requests for the laundry based on the text data.

In an alternative embodiment, the acquiring of the washing information from the operator terminal as the pickup and classification of the laundry is completed may include: acquiring a room number in which the laundry is picked up according to the reception request from the operator terminal; acquiring voice data or text data for an item and quantity of the laundry, and converting the voice data into text data when the voice data is acquired; and acquiring the washing information including the item and quantity of the laundry based on the text data.

In an alternative embodiment, the acquiring of the washing information from the operator terminal as the pickup and classification of the laundry is completed may include: acquiring a room number in which the laundry is picked up according to the reception request from the operator terminal; acquiring image data in which the laundry is photographed; and inputting the image data to a pre-trained laundry classification model to acquire washing information including the item and quantity of the laundry included in the image data.

In an alternative embodiment, the providing of the washing information and the cost information corresponding to the washing information to the user terminal may include: recognizing an item and quantity of the laundry included in the washing information; determining a washing cost corresponding to the item and quantity of the laundry; determining a first discount rate based on the item and quantity of the laundry; determining a second discount rate based on a service usage history of the user terminal; and generating the cost information by applying the first discount rate and the second discount rate to the washing cost, and providing the cost information to the user terminal.

In an alternative embodiment, the method may further include, when a washing confirmation input signal is obtained from the user terminal, generating guide information including a washing method of the laundry and a scheduled washing completion time based on the washing information; and providing the guide information to the user terminal.

In an alternative embodiment, the method may further include: generating a dashboard screen displaying a progress state of the laundry; and reflecting the progress state of the laundry and other laundry on the dashboard screen in real time and providing the same to the operator terminal.

In an alternative embodiment, the method may further include: collecting laundry management data related to a request for reception of the laundry, pickup, classification, and delivery; calculating a service usage rate for each period, an occupancy rate for each laundry item, and a user characteristic based on the laundry management data; generating promotion information for each user characteristic corresponding to a current time point based on the service usage rate for each period, the occupancy rate for each laundry item, and the user characteristic; and providing the promotion information to the user terminal and the operator terminal.

According to an embodiment of the present invention for solving the above problems, an apparatus is disclosed. The apparatus may include: a memory configured to store one or more instructions; and a processor configured to execute the one or more instructions stored in the memory, wherein the processor executes the one or more instructions to perform the above-described methods.

According to an embodiment of the present invention for solving the above-described problems, a computer program stored in a computer-readable recording medium in combination with a computer that is hardware to perform the above-described methods is disclosed.

Other specific matters of the present invention are included in the detailed description and drawings.

### Effects of the Invention

The present invention may provide an efficient and systematic service throughout the laundry management process. Specifically, the present invention may improve the work processing speed and accuracy by integrally managing all processes from the customer's laundry reception request to pickup, washing progress, and delivery completion.

In addition, the present invention provides a quick and accurate progress to a customer through real-time data communication between a user terminal and an operator terminal, thereby increasing service reliability and maximizing customer satisfaction. In particular, automatic text conversion of voice data and laundry item recognition using a pre-trained classification model provide the effect of reducing the effort of workers and minimizing the possibility of error occurrence.

The effects of the present disclosure are not limited to the effects mentioned above, and other effects not mentioned will be clearly understood by those skilled in the art from the following description.

### BRIEF DESCRIPTION OF DRAWINGS

FIG. 1 is a diagram illustrating a system according to an embodiment of the present invention.

FIG. 2 is a hardware configuration diagram of a computing device according to an embodiment of the present invention.

FIGS. 3 to 5 are views for explaining a method for providing a laundry management service according to an embodiment of the present invention.

### DETAILS FOR CARRYING OUT THE INVENTION

Various embodiments are now described with reference to the drawings. In the present specification, various descriptions are presented to provide an understanding of the present invention. However, it is apparent that such embodiments may be practiced without such a specific description.

As used herein, the terms “component,”“module,”“system,” and the like refer to computer-related entities, hardware, firmware, software, a combination of software and hardware, or execution of software. For example, a component may be, but is not limited to, a processor, an object, an execution thread, a program, and/or a computer that executes on the processor. For example, both the computing device and the application running on the computing device may be components. One or more components may reside within the processor and/or execution thread. One component may be localized within one computer. One component may be distributed between two or more computers. In addition, such components may run from various computer readable media having various data structures stored therein. The components may communicate via local and/or remote processes according to a signal having one or more data packets (e.g., data from one component interacting with another component in a local system, distributed system, and/or data transmitted over a network such as the Internet with another system via a signal), for example.

In addition, the term “or” is intended to mean an inclusive “or” rather than an exclusive “or”. That is, in the case not otherwise specified or not clear in context, “X uses A or B” is intended to mean one of the natural implicit substitutions. That is, when X uses A; X uses B; or X uses both A and B, “X uses A or B” may be applied in either of these cases. In addition, the term “and/or” as used herein should be understood to refer to and include all possible combinations of one or more of the enumerated related items.

In addition, the terms “include” and/or “including” should be understood to mean that corresponding features and/or components exist. However, it is to be understood that the terms “include” and/or “including” do not exclude the presence or addition of one or more other features, components, and/or groups thereof. In addition, when it is not otherwise specified or is not clear in the context as indicating a singular form, the singular number should be generally interpreted as meaning “one or more” in the present specification and the claims.

Those skilled in the art should further recognize that the various illustrative logical blocks, configurations, modules, circuits, means, logics, and algorithm steps described in connection with the embodiments disclosed herein may be implemented in electronic hardware, computer software, or combinations of both. To clearly illustrate the interchangeability of hardware and software, various illustrative components, blocks, configurations, means, logics, modules, circuits, and steps have been described above generally in terms of their functionality. Whether such functionality is implemented in hardware or software depends on the specific application and design limitations imposed on the overall system. Skilled technicians may implement the functionality described in various ways for each particular application. However, such decisions of implementation should not be interpreted as leaving the scope of the present invention.

The description of the presented embodiments is provided to be able to use or implement the present invention by those of ordinary skill in the art of the present invention. Various modifications of these embodiments will be apparent to those of ordinary skill in the art. The general principles defined herein may be applied to other embodiments without departing from the scope of the present invention. Thus, the present invention is not limited to the embodiments presented herein. The present invention should be interpreted in the broadest range consistent with the principles and novel features presented herein.

In the present specification, a computer refers to all types of hardware devices including at least one processor, and may be understood as encompassing a software configuration operating in a corresponding hardware device according to an embodiment. For example, the computer may be understood as including all of a smartphone, a tablet PC, a desktop, a laptop, and a user client and an application running on each device, but is not limited thereto.

Hereinafter, embodiments of the present invention will be described in detail with reference to the accompanying drawings.

Each of the steps described in the present specification is described as being performed by a computer, but the subject of each step is not limited thereto, and at least some of each step may be performed in different devices according to embodiments.

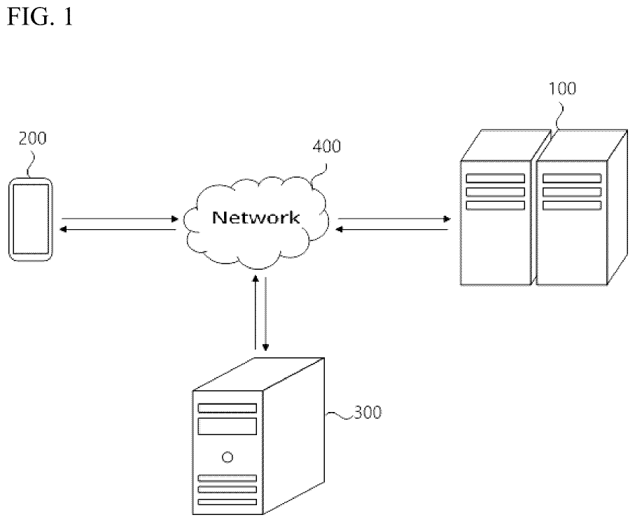

FIG. 1 is a diagram illustrating a system according to an embodiment of the present invention.

Referring to FIG. 1, a system according to an embodiment of the present disclosure may include a computing device 100, a user terminal 200, and an external server 300. The system illustrated in FIG. 1 is according to an embodiment, and the components thereof are not limited to the embodiment illustrated in FIG. 1, and may be added, changed, or deleted as necessary.

In an embodiment, the computing device 100 may provide a laundry management service. For example, the computing device 100 may manage the entire process from a laundry reception request to a pickup, a washing process, and a delivery completion, and may support efficient data communication between the user terminal 200 and the operator terminal.

Specifically, the computing device 100 may receive a laundry reception request from the user terminal 200. In addition, the computing device 100 may generate a pick-up request for laundry corresponding to the laundry reception request and transmit the pick-up request to the operator terminal. In addition, the computing device 100 may obtain the washing information from the operator terminal as the pick-up and classification of the laundry is completed. In addition, the computing device 100 may provide washing information and cost information corresponding to the washing information to the user terminal 200. In addition, when the washing confirmation input signal is obtained from the user terminal 200, the computing device 100 may transmit a washing start signal for the laundry to the operator terminal. In addition, when the washing of the laundry is completed, the computing device 100 may transmit the delivery location obtained from the user terminal 200 to the operator terminal and obtain delivery information from the operator terminal.

Accordingly, the computing device 100 of the present disclosure may improve service efficiency and reliability by supporting smooth data exchange between a user and a worker and systematically managing the entire process of the laundry management service.

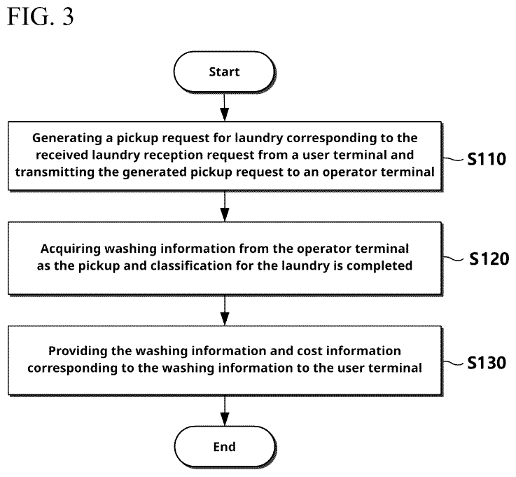

Hereinafter, an example of a method of providing a laundry management service by the computing device 100 will be described later with reference to FIGS. 3 to 5.

In various embodiments, the computing device 100 may provide a web or application-based service. However, the disclosure is not limited thereto.

The computing device 100 may include any type of computer system or computer device, such as, for example, a microprocessor, a mainframe computer, a digital processor, a portable device, and a device controller. However, the disclosure is not limited thereto.

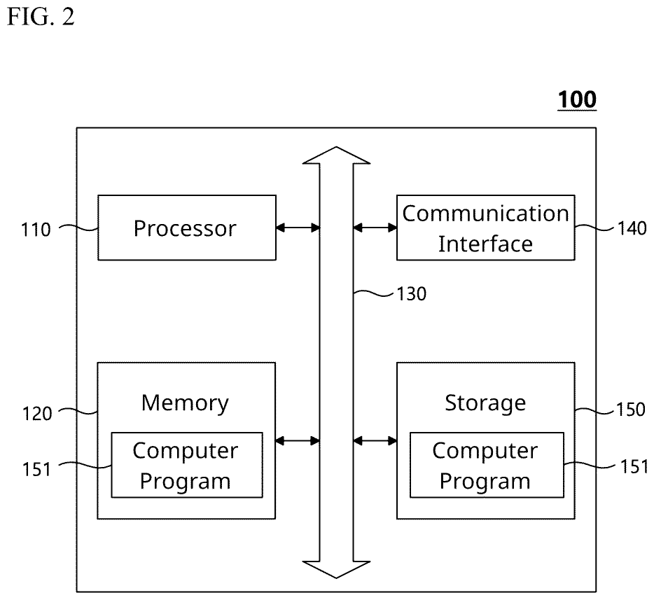

Hereinafter, the hardware configuration of the computing device 100 will be described later with reference to FIG. 2.

Meanwhile, the user terminal 200 may be connected to the computing device 100 through the network 400, and may be a terminal of a user who uses a laundry management service provided by the computing device 100.

Here, the user terminal 200 may include, for example, various types of computer devices. For example, the user terminal 200 may refer to various terminal devices such as a smart phone, a tablet PC, a desktop, and a laptop.

The user terminal 200 may include a display in at least a portion of the terminal, and may include an operating system for driving an application or an extension program-based service provided from the computing device 100. For example, the user terminal 200 may be a smart-phone, but is not limited thereto, and the user terminal 200 is a wireless communication device that guarantees portability and mobility, and may include any type of handheld-based wireless communication device such as a navigation device, a personal communication system (PCS), a global system for mobile communications (GSM), a personal digital cellular (PDC), a personal handyphone system (PHS), a personal digital assistant (PDA), an international mobile telecommunication (IMT)-2000, a code division multiple access (CDMA)-2000, W-code division multiple access (W-CDMA), a wireless broadband Internet (Wibro) terminal, a smart pad, a tablet pc, and the like.

The external server 300 may be connected to the computing device 100 through the network 400, may transmit and receive various types of information/data required for the computing device 100 to provide the laundry management service, and may store and manage various types of information/data generated as the computing device 100 provides the laundry management service.

For example, the external server 300 may be a database server that stores information used in a method of providing a laundry management service. For another example, the external server 300 may be a server that provides information used in a method of providing a laundry management service.

The network 400 may refer to a connection structure capable of exchanging information between respective nodes such as a computing device, a plurality of terminals, and servers. For example, the network 400 includes Local Area Network (LAN), Wide Area Network (WAN), World Wide Web (WWW), a wired/wireless data communication network, a telephone network, a wired/wireless television communication network, and the like.

Wireless data communication networks include 3G, 4G, 5G, 3rd Generation Partnership Project (3GPP), 5th Generation Partnership Project (5GPP), Long Term Evolution (LTE), World Interoperability for Microwave Access (WIMAX), Wi-Fi, Internet, Local Area Network (LAN), Wireless Local Area Network (Wireless LAN), Wide Area Network (WAN), Personal Area Network (PAN), Radio Frequency (RF), Bluetooth network, Near Field Communication (NFC) network, satellite broadcasting network, analog broadcasting network, Digital Multimedia Broadcasting (DMB) network, but is not limited thereto.

FIG. 2 is a hardware configuration diagram of a computing device according to an embodiment of the present invention.

Referring to FIG. 2, the computing device 100 according to an embodiment of the present disclosure may include one or more processors 110, a memory 120 for loading a computer program 151 executed by the processors 110, a bus 130, a communication interface 140, and a storage 150 for storing the computer program 151. Here, only components related to the embodiment of the present invention are illustrated in FIG. 2. Accordingly, those skilled in the art to which the present disclosure pertains may further include other general-purpose components in addition to the components shown in FIG. 2.

The processor 110 controls the overall operation of each component of the computing device 100. The processor 110 may include one or more cores, and may include a processor for data analysis and deep learning such as a central processing unit (CPU), a general purpose graphics processing unit (GPGPU), a tensor processing unit (TPU), and the like. Alternatively, it may be configured to include any type of processor well known in the technical field of the present invention.

In addition, the processor 110 may perform an operation on at least one application or program for executing the method according to embodiments of the present disclosure, and the computing device 100 may include one or more processors.

In various embodiments, the processor 110 may further include a Random Access Memory (RAM) (not shown) and a Read-Only Memory (ROM) (not shown) that temporarily and/or permanently store a signal (or data) processed in the processor 110. In addition, the processor 110 may be implemented in the form of a system on chip (SoC) including at least one of a graphic processing unit, a RAM, and a ROM.

The memory 120 stores various data, commands, and/or information. The memory 120 may load the computer program 151 from the storage 150 to execute the method/operation according to various embodiments of the present invention. When the computer program 151 is loaded into the memory 120, the processor 110 may perform the method/operation by executing one or more instructions constituting the computer program 151. The memory 120 may be implemented as a volatile memory such as a RAM, but the technical scope of the present disclosure is not limited thereto.

The bus 130 provides a communication function between components of the computing device 100. The bus 130 may be implemented as various types of buses such as an address bus, a data bus, and a control bus.

The communication interface 140 may support wired/wireless Internet communication of the computing device 100. In addition, the communication interface 140 may support various communication methods other than Internet communication. To this end, the communication interface 140 may be configured to include a communication module well known in the technical field of the present invention. In some embodiments, the communication interface 140 may be omitted.

The storage 150 may store the computer program 151 non-temporarily. When a process according to an embodiment of the present invention is performed through the computing device 100, the storage 150 may store various information necessary to perform the method according to the disclosed embodiment or to provide a service.

The storage 150 may include a non-volatile memory such as a read only memory (ROM), an erasable programmable ROM (EPROM), an electrically erasable programmable ROM (EEPROM), a flash memory, a hard disk, a removable disk, or any type of computer-readable recording medium well known in the art to which the present invention pertains.

The computer program 151 may include one or more instructions that, when loaded into the memory 120, cause the processor 110 to perform methods/operations according to various embodiments of the present invention. That is, the processor 110 may perform the method/operation according to various embodiments of the present disclosure by executing the one or more instructions.

In an embodiment, the computer program 151 may include one or more instructions to perform various methods related to various tasks related to training of a neural network model.

The steps of the method or algorithm described in connection with the embodiment of the present invention may be directly implemented in hardware, implemented as a software module executed by hardware, or implemented by a combination thereof. The software module may reside in a random access memory (RAM), a read only memory (ROM), an erasable programmable ROM (EPROM), an electrically erasable programmable ROM (EEPROM), a flash memory, a hard disk, a removable disk, a CD-ROM, or any form of computer-readable recording medium well known in the art to which the present invention pertains.

The components of the present invention may be implemented as a program (or application) and stored in a medium to be executed in combination with a computer that is hardware. The components of the present disclosure may be implemented by software programming or software elements, and similarly, the embodiments may be implemented by programming or scripting languages such as C, C++, Java, assembler, or the like, including various algorithms implemented by a combination of data structures, processes, routines, or other programming components. Functional aspects may be implemented with an algorithm running on one or more processors.

FIGS. 3 to 5 are views for explaining a method for providing a laundry management service according to an embodiment of the present invention.

Referring to FIG. 3, the computing device 100 may receive a laundry reception request from the user terminal 200. In addition, the computing device 100 may generate a pick-up request for laundry corresponding to the laundry reception request and transmit the pick-up request to the operator terminal (S110). Here, the computing device 100 may collectively process a process of generating a pick-up request in conjunction with receiving a laundry reception request from the user terminal 200 and transmitting the pick-up request to the operator terminal.

That is, when a request for reception is received from the user terminal 200, the computing device 100 may sequentially process the steps of analyzing the content of the request and configuring the pickup request data without separately distinguishing them. For example, the computing device 100 may convert information such as items, quantities, and request times transmitted from the user terminal 200 into an internal data structure, and may automatically generate essential items (e.g., a room number, a desired pick-up time point, and special items) required for a pick-up request and transfer the generated essential items to the operator terminal. Through this, a pick-up request is issued as soon as the user completes the request, thereby minimizing the delay between the application and the pick-up process.

In addition, the computing device 100 may use a voice input or an automatic translation module together in the process of recognizing the reception request content of the user terminal 200. By using this, it is possible to convert voice data into text and configure pickup request information at the same time, and transmit a signal to an operator terminal in charge of pickup work as soon as the request is completed. For example, when the user makes a voice request “pick up 3 shirts by 2 p.m.”, the computing device 100 converts the voice request into text, immediately generates a pick-up request based on the content, and transmits the pick-up request to the operator terminal, thereby processing the reception and pick-up request steps as one flow.

This batch processing method minimizes the communication stage between the user and the worker, and prevents errors or omissions that may occur due to delays in pick-up after reception. Meanwhile, the operator terminal may start the scheduling task as soon as receiving the pick-up request transmitted from the computing device 100, and may provide the service quickly and accurately by adjusting the priority in real time even when several pick-up requests are simultaneously received.

Specifically, the computing device 100 may obtain a room number from the user terminal 200.

For example, the computing device 100 may parse the room number included in the text message or the voice message transmitted from the user terminal 200 and record the corresponding information in the internal database to classify the reception request. In addition, when the reception request is transmitted in a voice form, the computing device 100 may be implemented to convert the reception request into text using a voice recognition module and then find a room number in the converted text. In this process, the computing device 100 may check the signal strength of the user terminal 200 to check whether actual communication has been performed normally, and may send a retransmission request to ensure data integrity so that an error does not occur when necessary.

In addition, the computing device 100 may obtain voice data or text data requesting reception of laundry from the user terminal 200, and when the voice data is obtained, the voice data may be converted into text data. In addition, the computing device 100 may recognize a reception request for the laundry based on the text data.

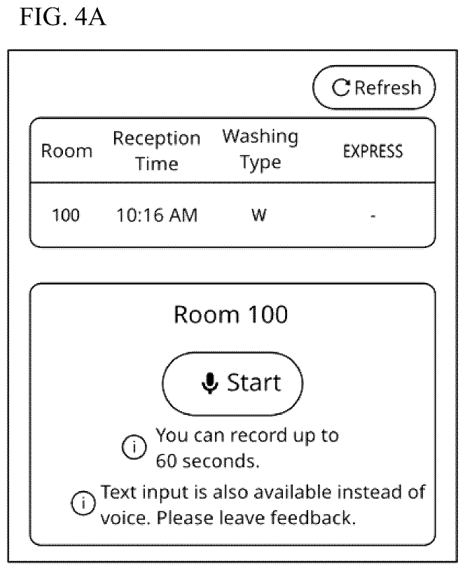

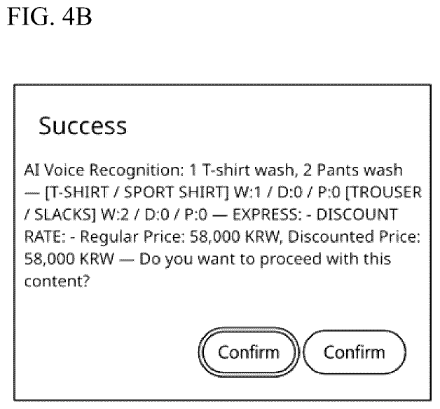

For example, as illustrated in FIG. 4A, the computing device 100 may acquire the information on the laundry as a voice in a state in which the room number 100, the reception time 10:16 AM, and the washing type W are recognized. The user may select a start button included in the screen displayed on the user terminal 200 and request information on laundry to be received by voice. Meanwhile, the computing device 100 may display laundry items recognized based on the voice input from the user terminal 200 as shown in FIG. 4B to be checked by the user.

In addition, the computing device 100 may extract an item name such as “T-shirt” or “pants” from the converted text, and classify the reception request by identifying information such as the number of times of washing requested by the user or the desired completion time. In this classification process, the computing device 100 may use the natural language processing module to find core keywords included in the voice command, and may automatically assign a reservation schedule in consideration of the laundry pickup time.

Additionally, when the context described in the text data is unclear, the computing device 100 may transmit an additional guide message to the user terminal 200 to request supplementary information, thereby preventing omission or confusion in laundry reception.

Meanwhile, the computing device 100 creates pick-up instruction information in a form that is easy for the operator terminal to understand based on the room number, laundry item, quantity, request time, and the like received from the user terminal 200.

For example, the computing device 100 may generate detailed instructions such as “room 100, one T-shirt, two bottoms, and a pick-up request before 2 PM” in a text form and transmit the generated detailed instructions to the operator terminal. If the operator terminal is in a situation in which several pickup requests may be accepted at the same time, the computing device 100 may reduce the waste of the worker's movement by configuring and providing the pickup movement in the most appropriate order through an internal algorithm. In the step of generating the pick-up request, the computing device 100 may check whether the VIP of the user who has requested the reception of the laundry or whether additional personnel handling the special laundry is needed, and the like, so that the worker may receive necessary information before performing the actual work.

In an embodiment, the computing device 100 may obtain the washing information from the operator terminal as the pickup and classification of the laundry is completed (S120).

For example, the computing device 100 may obtain a room number from which the laundry is picked up according to a reception request from the operator terminal. In addition, the computing device 100 may obtain voice data or text data for the item and quantity of laundry, and when the voice data is obtained, the voice data may be converted into text data. In addition, the computing device 100 may obtain washing information including the item and quantity of laundry based on the text data.

For example, the computing device 100 may analyze the text “Room 100, 1 T-shirt, 2 bottoms, and confirmation completed” transmitted from the operator terminal to update the final washing item list in the internal record.

Meanwhile, when the result of actually checking the laundry and the content of the user request are different from each other (e.g., additional discovery of the laundry, change in the number of items, etc.), the operator terminal transmits the modified information, and the computing device 100 may readjust the laundry request list through this.

As another example, the computing device 100 may obtain a room number from which laundry is picked up according to a reception request from the operator terminal. In addition, the computing device 100 may obtain image data in which laundry is photographed. In addition, the computing device 100 may input the image data to the pre-trained laundry classification model to obtain washing information including the item and quantity of laundry included in the image data.

For example, the computing device 100 may use a clothing recognition model that learns color, shape, texture, and the like from a large amount of clothing images to automatically distinguish shirts, pants, towels, blankets, and the like, and then infer the corresponding quantity. In addition, when a worker photographs and transmits several images, the computing device 100 may minimize duplicate recognition of clothes or partial omission by synthesizing the results of each image. In addition, the clothing recognition model may extract the shape or pattern of clothing based on pre-trained features and classify it with high accuracy even when the image quality is low or laundry overlaps. The computing device 100 may reflect the classification result in the washing information, and may determine the final information by requesting confirmation from the worker if necessary.

In various embodiments, the laundry management service of the present disclosure may provide a service of revisiting the laundry after a predetermined time elapses without immediately picking up the laundry when the user displays a do not disturb.

Specifically, the computing device 100 may identify that the corresponding user room is currently in the Do Not Disturb state based on the information (e.g., the user's Do Not Disturb state) received from the operator terminal.

For example, when the worker provides information indicating that the worker attempted to pick up the laundry but was inaccessible due to the “do not disturb” sign, the computing device 100 may record the time point and readjust the pick-up schedule. In this case, the computing device 100 may check whether there is a preset “do not disturb” time or an alternative time zone designated by the user, and accordingly, may organize a revisit schedule at a specific time (e.g., after 1 hour or at a time requested by the user).

More specifically, when receiving a message “Room 503, No Pickup due to Do Not Disturb Indication” from the operator terminal, the computing device 100 may recognize the worker's entire work path. In addition, the computing device 100 may check the revisit available time so as not to conflict with other laundry pickup or delivery tasks currently in progress, and may delay the pickup schedule of the corresponding room to a specific time point.

Through this, the computing device 100 may manage to prevent excessive blanks or duplicate visits from occurring in the worker's movement path, and may be considered not to visit at a time that the user does not want. For example, if the rule “revisit within at least one hour after the Do Not Disturb state is released” is set in advance, the computing device 100 calculates the post time, puts a pick-up command in the next available schedule, and transmits a notification to the operator terminal.

That is, the computing device 100 may coordinate the entire process to retrieve laundry at an appropriate time while respecting the user privacy requirements. In addition, even if a pickup delay occurs, since a scheduled revisit time is clearly registered in the system, a worker may check a revisit schedule through his/her terminal screen without a separate manual memo.

In an embodiment, the computing device 100 may provide the washing information and the cost information corresponding to the washing information to the user terminal 200 (S130).

Specifically, the computing device 100 may recognize the item and quantity of laundry included in the washing information. In addition, the computing device 100 may determine the washing cost corresponding to the item and quantity of the laundry.

For example, the computing device 100 may calculate a cost by reviewing a preset unit price and work difficulty for “three shirts”, and calculate a basic cost by multiplying the unit price by the laundry quantity. Subsequently, when an additional cost according to the laundry material (e.g., silk, waterproof material, etc.) is required, the final amount may be calculated by adding the additional cost.

In addition, the computing device 100 may determine the first discount rate based on the item and quantity of laundry. In addition, the computing device 100 may determine the second discount rate based on the service usage history of the user terminal 200.

For example, the computing device 100 may determine whether there is an additional discount item by checking the number of laundry requests, accumulated points, subscription-type membership, and the like that have previously occurred in the same room.

In addition, the computing device 100 may generate the cost information by applying the first discount rate and the second discount rate to the washing cost, and provide the cost information to the user terminal 200.

For example, the computing device 100 may configure the guide message so that the user clearly understands the reason for the discount and the final payment amount by displaying the specific discount details in the cost information.

In various embodiments, when the washing confirmation input signal is obtained from the user terminal 200, the computing device 100 may transmit a washing start signal for the laundry to the operator terminal.

Specifically, the computing device 100 may recognize an input such as a “washing progress” button selection or a voice command displayed on the user terminal 200, and accordingly, may transmit a “washing start” instruction to the operator terminal.

For example, the computing device 100 may analyze the desired washing completion time designated by the user terminal 200 to calculate an appropriate washing start time in consideration of the state of the washing equipment and the arrangement of the workers. In addition, the computing device 100 may transmit information on the washing operation to the operator terminal. The worker may operate the equipment at the corresponding time zone by referring to the information received from the computing device 100 or may process the laundry by assigning work.

In addition, when the washing of the laundry is completed, the computing device 100 may transmit the delivery location obtained from the user terminal 200 to the operator terminal and obtain delivery information from the operator terminal.

Specifically, the computing device 100 may recognize a delivery place (front desk, unmanned locker, specific room, etc.) input from the user terminal 200, and may guide the corresponding place, delivery priority, expected delivery time, and the like to the operator terminal.

For example, the computing device 100 may measure each delivery location and distance when there are several requests at the same time and provide the operator terminal with route information to move most efficiently. The worker may perform the delivery process based on the route information provided through the operator terminal, and finally report the result of delivering the laundry to the corresponding place to the computing device 100. The computing device 100 may record the delivery completion time and completion state in the internal database by reflecting the report, and transmit a “delivery completion” notification message to the user terminal 200 to complete the laundry management service.

Accordingly, the computing device 100 may automatically track and manage the overall washing process, and may provide various information so that the user may understand the location and state of the laundry without making a separate inquiry.

According to various embodiments of the disclosure, when a washing confirmation input signal is obtained from the user terminal 200, the computing device 100 may generate guide information including a washing method of laundry and a scheduled washing completion time based on the washing information. In addition, the computing device 100 may provide the guide information to the user terminal 200.

Specifically, the computing device 100 may recommend a suitable washing course (e.g., general water washing, dry cleaning, special coating removal, etc.) in consideration of the material characteristics, pollution level, weight, and the like of the laundry requested by the user terminal 200, and may calculate the working time based on the corresponding washing course.

For example, the computing device 100 may compare the average processing time for each course with the current laundry equipment occupancy state to calculate an expected schedule such as “expected to be completed after about 4 hours” and provide it to the user terminal 200. In addition, the computing device 100 may recalculate the expected completion time whenever the progress on the operator terminal side is updated and provide it to the user terminal 200 in real time.

Accordingly, the computing device 100 may start the washing operation step based on the washing confirmation input of the user terminal 200 and provide transparent information of the entire process to the user by dynamically adjusting the scheduled washing completion time if necessary.

In an additional embodiment, the computing device 100 may dynamically adjust a work environment based on a washing history accumulated in the process of performing a washing operation, an equipment operation log, a user inquiry history, and the like.

For example, the computing device 100 may automatically recommend the laundry equipment distribution or additional manpower input time by comprehensively considering the washing completion time of the previously processed clothes of similar materials, the delay factor occurring in a specific washing course, the current time operating rate of the operator terminal, and the like. To this end, the computing device 100 may analyze the laundry processing flow using a machine learning model or a prediction algorithm, identify bottleneck sections or frequent causes of errors for each step, and then guide necessary measures to an operator terminal or a manager screen.

In addition, when calculating the estimated washing completion time based on the washing confirmation input signal, the computing device 100 may calculate a more accurate prediction value by combining the average processing time of past similar cases as well as the current device state. For example, when the dry cleaning work of the high-quality material is continuously received, since the drying time is more likely to be longer than usual, the computing device 100 may set the expected completion time to be longer than usual in consideration of the corresponding matter, and notify the user terminal 200 of the reason together. The computing device 100 may enable efficient work arrangement from the perspective of a worker through such a prediction method, and when an exceptional situation such as an unexpected situation or a delay due to equipment inspection occurs, automatically re-calculation may be performed to provide updated guide information to the user terminal 200.

In addition, the computing device 100 may identify a correlation between a washing course applied to laundry and a delivery option requested by the user to optimize a logistics flow to a delivery point (e.g., a room, an unmanned locker, a site reception place). For example, when a plurality of items having increased volume occur in the packaging step after washing, the computing device 100 may transmit a notification to the operator terminal to prepare manpower or equipment (cart, mobile robot, etc.) in advance. This reduces the risk of delay or loss in the delivery process after washing is completed, and allows users to deliver laundry accurately within the scheduled delivery time.

Accordingly, the computing device 100 may be flexibly updated according to an environment change of a pre-laundry management process, so that both the user and the worker may recognize the situation in real time and actively respond to the situation. As a result, the computing device 100 may intelligently utilize the collected laundry processing data to simultaneously improve work efficiency and service quality.

According to various embodiments of the disclosure, the computing device 100 may generate a dashboard screen that displays the progress of the laundry. In addition, the computing device 100 may reflect the progress of the laundry and other laundry on the dashboard screen in real time and provide the same to the operator terminal.

Specifically, the computing device 100 may display steps such as reception completion, pickup waiting, washing in progress, drying, delivery preparation, and delivery in icons or colors, respectively, to help the worker intuitively grasp the situation.

For example, the computing device 100 may automatically recognize when the operator terminal starts a drying process of a specific laundry, update the corresponding laundry icon on the dashboard, and send a notification in advance to the person in charge if another laundry needs to be immediately followed by using the laundry equipment. The dashboard configured in this way may systematically manage sequential steps occurring in the laundry processing process and support to check in advance delay factors or manpower allocation problems that may occur.

Accordingly, the computing device 100 may implement an efficient and stable laundry management service through real-time monitoring and data integration even in a complex environment in which several laundry requests are simultaneously received.

In an additional embodiment, the computing device 100 may dynamically re-adjust the work schedule by re-evaluating the expected processing time and the availability of manpower in real time based on the laundry progress state displayed on the dashboard screen.

For example, the computing device 100 may predict the remaining drying time when a specific laundry enters the drying stage while tracking the usage state of the washing equipment updated in units of minutes, and may pre-calculate the input time of the next waiting laundry. Through this process, laundry equipment can be operated in an optimized order, and even if unexpected delay factors occur, workers can be immediately notified to minimize damage. Such a re-adjustment function may be particularly useful during peak times when laundry is concentrated, and may reduce the space time of personnel and equipment even when multiple requests are received at the same time.

In addition, the computing device 100 may collect and analyze data of a dashboard screen to identify an average processing time for a specific washing course, a day or time of day when laundry is mainly concentrated, a frequently occurring cause of delay, and the like, and based on this, may improve equipment inspection schedules or worker work arrangements.

For example, when the dryer of the frequently used washing course is in an aging state or a bottleneck phenomenon occurs frequently due to a concentration of orders at a specific time, the computing device 100 may provide a notification to the manager to review equipment replacement or additional manpower input.

In addition, when the operator terminal selects a specific laundry on the dashboard, the computing device 100 may immediately display a past history of the corresponding laundry or customer-specific matters (e.g., a request for removing an allergy-causing substance, precautions for handling a high-quality material, etc.). That is, the computing device 100 may provide a function capable of quickly inquiring detailed information for each laundry, and such a function may induce a quick response when a quality problem or additional requirement is raised during the washing process, thereby maintaining stable service quality even in a large-scale work environment. Particularly, in a facility such as a hotel or a hospital that requires a level of hygiene management, every step of handling laundry can be tracked and recorded, and a problem history occurring in each step can be transparently checked, thereby reducing errors in laundry processing.

Accordingly, the computing device 100 may not only simply visualize the laundry progress state information displayed on the dashboard screen, but may combine the laundry progress state information with various operation functions such as work rescheduling, equipment state analysis, and laundry history inquiry, thereby supporting a quick and flexible response even in a complex site where several laundry requests are simultaneously received.

According to various embodiments of the disclosure, the computing device 100 may provide appropriate promotion information to the user based on the laundry management data.

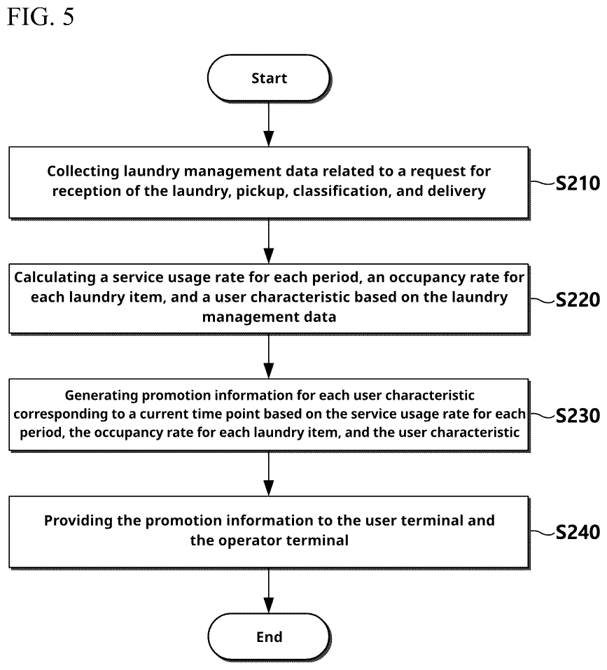

Referring to FIG. 5, the computing device 100 may collect laundry management data related to a request for reception of laundry, pickup, classification, and delivery (S210).

Specifically, the computing device 100 may accumulate information including text, voice, image, delivery history, and the like transmitted from the user terminal 200 or the operator terminal by interworking with an internal database or an external server.

For example, the computing device 100 may collect information such as an reception time, a laundry item and quantity, a request time, and a payment method transmitted from the user terminal 200 to accumulate a laundry processing history. The operator terminal may report the pickup execution time, classification result, washing completion time, delivery delay history, and the like to the computing device 100 in real time, and the computing device 100 may manage the history for each laundry based on this information.

In an embodiment, the computing device 100 may calculate the service usage rate for each period, the occupancy rate for each laundry item, and the user characteristic based on the laundry management data (S220).

Specifically, the computing device 100 may set various ranges such as weekly, monthly, and quarterly based on the period classification, and may calculate the service usage rate by comparing the number of applications and the number of completions for each section. In addition, the computing device 100 may extract the appearance frequency for each item by analyzing the laundry classification record. For example, the computing device 100 may determine whether a lot of shirts are received, when bedding is mainly concentrated, and the like.

For example, the computing device 100 may compare the laundry request details received by the user terminal 200 with the washing information actually processed by the operator terminal to recognize when specific items such as clothes, towels, curtains, and carpets are concentrated, and recognize what characteristics the main user group represents by combining the past usage details for each user and the payment amount. In addition, the computing device 100 may recognize user characteristics including laundry type preference, usage pattern, reservation frequency, time zone of reception and washing completion request, and the like.

The computing device 100 may generate promotion information for each user characteristic corresponding to the current time point based on the service usage rate for each period, the occupancy rate for each laundry item, and the user characteristic (S230).

Specifically, when detecting a pattern in which a specific user entrusts the same item on the same day of the week, the computing device 100 may prepare a discount benefit or additional service guidance in advance before the corresponding day of the week. In addition, the computing device 100 may generate the promotion information by recommending a thick bedding washing promotion in winter and a thin clothing or towel washing promotion in summer in consideration of seasonal factors.

For example, when a time when bedding washing rapidly increases is tracked in the monthly data, the computing device 100 may automatically generate a “bedding washing discount event” according to the corresponding time, and may be set to intensively transmit a promotion message to a group having similar user characteristics. During the promotion generation process, the computing device 100 may configure a personalized benefit in consideration of the user's laundry history, membership grade, past discount rate application situation, and the like, and may record the details thereof in an internal database to effectively manage the details without loss or duplication.

The computing device 100 may provide the promotion information to the user terminal 200 and the operator terminal (S240).

Specifically, the computing device 100 may expose the promotion to the user terminal 200 in various forms such as an event notification, a push message, a messenger application, and the like, so that the user may quickly check the corresponding benefit.

For example, the computing device 100 may display a notification window on the user terminal 200 with contents such as “20% discount on bedding washing this month, additional points are paid when using the weekend”, and may allow the user to immediately connect to the reception screen when the user taps or clicks on the notification window. By sharing the same promotion information with the operator terminal, it is possible to check in advance so that work processing is not delayed when the laundry subject to the discount is received. This allows workers to recognize in advance which items are intensively covered with discounts or benefits, and to relocate laundry personnel or adjust logistics plans as needed.

Accordingly, the computing device 100 may comprehensively grasp the user and item characteristics by accumulating laundry management data in real time and analyzing the laundry management data in various angles, and may reflect the analysis result in the promotion strategy to provide necessary information to both the user terminal 200 and the operator terminal at an appropriate time. Through this, the computing device 100 may increase both the inflow of new users and the satisfaction of existing users. In addition, the computing device 100 may support to perform a prediction-based plan for the amount of laundry from the perspective of a worker or a manager.

According to an additional embodiment of the present disclosure, the computing device 100 may automate location tracking and state analysis of the laundry by integrally utilizing an image and voice recognition system linked with an electronic tag (e.g., RFID, NFC, etc.) attached to the laundry.

Specifically, the computing device 100 may perform the step of scanning the electronic tag information in the process of receiving the laundry to classify each laundry as a unique identifier, and then checking the corresponding situation through the recognition device whenever the laundry moves or the washing process starts, proceeds, or is completed. In addition, the computing device 100 may also perform a step of measuring the moisture content inside the laundry or the degree of contamination on the laundry in real time by analyzing the thermal image obtained by photographing the surface of the laundry.

More specifically, the computing device 100 may input the captured thermal image to a pre-trained deep learning model to calculate an optimal washing temperature condition or an expected drying time for a specific laundry, and transmit a notification to an operator terminal to adjust a process of increasing or drying the washing time compared to an existing washing course if necessary.

For example, the computing device 100 may provide a guide message such as “an additional 5 minutes of drying is recommended because the current humidity is higher than the reference value” to the operator by combining the material (e.g., cotton, polyester, wool, silk, etc.) of the laundry acquired through the electronic tag with the thermal image to compare and evaluate the actual drying state and the estimated drying time.

In detail, for example, when it is determined that a specific laundry has a more serious stain or a risk of microbial reproduction than expected by combining the real-time contamination level evaluation result and the dry state tracking information, the computing device 100 may automatically perform a step of suggesting a sterilization course or a sterilization drug injection process. In this case, the computing device 100 may provide a specific guideline indicating which sterilization drug is suitable and how much the temperature should be maintained.

Accordingly, the computing device 100 may simultaneously increase washing quality and process efficiency by providing various functions such as electronic tag-based location tracking, thermal image analysis, and additional sterilization course recommendation.

Although embodiments of the present disclosure have been described with reference to the accompanying drawings, those skilled in the art to which the present disclosure pertains will understand that the present disclosure may be practiced in other specific forms without changing the technical spirit or essential features thereof. Therefore, it should be understood that the embodiments described above are illustrative in all aspects and are not restrictive.

1. A laundry management service providing method performed by a computing device including at least one processor, the method comprising:
generating a pickup request for laundry corresponding to the received laundry reception request from a user terminal and transmitting the generated pickup request to an operator terminal;
acquiring washing information from the operator terminal as the pickup and classification of the laundry is completed; and
providing the washing information and cost information corresponding to the washing information to the user terminal.

2. The laundry management service providing method of claim 1, further comprising:
transmitting a washing start signal for the laundry to the operator terminal when the washing confirmation input signal is obtained from the user terminal; and
transmitting a delivery location obtained from the user terminal to the operator terminal and obtaining delivery information from the operator terminal when the washing of the laundry is completed.

3. The laundry management service providing method of claim 1, wherein the generating of the pick-up request for the laundry corresponding to the laundry reception request received from the user terminal and transmitting the pick-up request to the operator terminal comprises:
obtaining a room number from the user terminal;
obtaining voice data or text data requesting reception of the laundry from the user terminal, and
converting the voice data into text data when the voice data is obtained; and recognizing the laundry reception request based on the text data.

4. The laundry management service providing method of claim 1, wherein the acquiring of the washing information from the operator terminal as the pickup and classification of the laundry is completed comprises:
acquiring a room number in which the laundry is picked up from the operator terminal according to the reception request;
acquiring voice data or text data for an item and quantity of the laundry, and converting the voice data into text data when the voice data is acquired; and
acquiring the washing information including the item and quantity of the laundry based on the text data.

5. The laundry management service providing method of claim 1, wherein the obtaining of the washing information from the operator terminal as the pickup and classification of the laundry is completed comprises:
acquiring a room number in which the laundry is picked up from the operator terminal according to the reception request;
acquiring image data in which the laundry is photographed; and
acquiring the washing information including the item and quantity of the laundry included in the image data by inputting the image data to a pre-trained laundry classification model.

6. The laundry management service providing method of claim 4, wherein the providing of the washing information and the cost information corresponding to the washing information to the user terminal comprises:
recognizing an item and quantity of the laundry included in the washing information;
determining a washing cost corresponding to the item and quantity of the laundry;
determining a first discount rate based on the item and quantity of the laundry;
determining a second discount rate based on a service usage history of the user terminal; and
generating the cost information by applying the first discount rate and the second discount rate to the washing cost, and providing the cost information to the user terminal.

7. The laundry management service providing method of claim 1, further comprising:
generating guide information including a washing method of the laundry and a scheduled washing completion time based on the washing information when a washing confirmation input signal is obtained from the user terminal; and
providing the guide information to the user terminal.

8. The laundry management service providing method of claim 1, further comprising:
generating a dashboard screen displaying a progress state of the laundry; and
reflecting the progress state of the laundry and other laundry on the dashboard screen in real time and providing the same to the operator terminal.

9. The laundry management service providing method of claim 1, further comprising:
collecting laundry management data related to a request for reception of the laundry, pickup, classification, and delivery; calculating a service utilization rate for each period, occupancy rate for each laundry item, and a user characteristic based on the laundry management data;
generating promotion information for each user characteristic corresponding to a current time point based on the service usage rate for each period, the laundry item occupancy rate, and the user characteristic; and
providing the promotion information to the user terminal and the operator terminal.

10. An apparatus comprising: a memory configured to store one or more instructions; and a processor configured to execute the one or more instructions stored in the memory, wherein the processor executes the one or more instructions to perform the method of claim 1.

11. A non-transitory computer-readable recording medium storing a computer program which, when executed by a processor, causes the processor to perform the method of claim 1.
